(19) United States
(12) Patent Application Publication
(10) Pub. No.: US 2019/0311334 A1
(43) Pub. Date: Oct. 10, 2019

(54) Accelerated Check Processing

(71) Applicant: Chase Wellington Gillman, Garland, TX (US)

(72) Inventor: Chase Wellington Gillman, Garland, TX (US)

(21) Appl. No.: 15/947,735

(22) Filed: Apr. 6, 2018

(51) Int. Cl. G06Q 20/04; G06Q 20/10; G07D 7/00

(52) U.S. Cl. CPC G06Q 20/042; G07D 7/003; G06Q 20/108

(57) ABSTRACT

This disclosure includes devices systems, and methods for accelerating the processing of actual paper check documents by a payee. The Accelerated Check documents are in all respects duplicative of current paper checks in common use, and are processed through the banking system the same. All levels of security in common use by banks and check processors are likewise available to payees utilizing Accelerated Check Processing plus additional security measures that are unique to the current invention. Those security measures includes digital depositing data for Positive Pay at payer's bank and a paver supplied Security Device Interface with USB connectivity in payee's hardware, such device containing an serial circuit to generate a digital unique code used in the process of Positive Pay for each Accelerated Check. The unique code is composited from payee's machine key, the payer's server data and the serial circuit data.

The present application claims priority to the earlier filed provisional application having Ser. No. 62/602,045, and hereby incorporates subject matter of the provisional application in its entirety.

### FIELD OF INVENTION

This invention relates to accelerating Check delivery to a payee registered in a Payee Portal to receive payments from a payer, also registered and utilizing the Payee Portal, for invoices filed by the payee for payment from a payer

### BACKGROUND OF THE INVENTION

Historically, commerce relies on checks, bank wires, and automated clearinghouse transactions for payers to compensate payees for goods and services. Credit cards and virtual credit cards have been used extensively since 2002 as a means to make payments between payers and payees on a somewhat more timely basis. Those forms of payment have advantages and disadvantages based upon timeliness versus cost of payment.

Bank wires, credit cards, and virtual credit cards are same-day transactions but are also the most costly. Checks and automated clearinghouse transactions have low transaction fees but longer delivery times. All these forms of payment can be costly to the payer and the inclusion of the remittance detail associated with the payment drives the cost even higher. The inefficiencies and cost to the payer added to the increased cost for timeliness of payment for the payee must be addressed by technology.

The problem to be addressed is twofold: 1.) the higher cost of faster payments and 2.) the potential for theft when using digital and electronic transmission of payment information. A faster payment is to the advantage of the payee and within the current state-of-the-art we find that assumption to be true. Payees offer discounts to payers for quicker payment. Because payees will accept a discounted payment for quicker payments, the corollary is also true. Payers may offer quicker payment to payees for a discount of the cost from the payee. Credit cards and virtual credit cards are quicker forms of payment so offered to payees by payers.

Credit cards and virtual credit cards have high merchant fees that are charged to the payee (these fees may be as high as 3% of the payment). The payee in order to recover the cost of the merchant fee requires the payer to pay a convenience fee. Convenience fees charged by payees are a common occurrence when a payer uses a credit card or virtual credit card. For the payer, the opportunity to make payment without print and mail cost of a check, are often offset by a payee enforcing a “convenience fee” for the use of the credit card. The convenience fee offsets credit card merchant fees the payee pays the credit card network.

A long-felt but unfulfilled need in the art is that commerce needs a payment type that is totally secure, has very low fees for both the payer and the payee and can be instantaneously delivered to the payee by the payer.

### SUMMARY OF INVENTION

The present invention facilitates speed of payment at a very low cost in a totally secure and encrypted environment through the use of effective but inexpensive computer hardware and greatly reduces or eliminates transactional costs incurred by payers and payees while offering immediate delivery of payment and the associated remittance detail to payees with a significant reduction in cost to the payer.

An embodiment of the invention includes the payer creating a digital remittance advice (Advice) for a payment from a data file of payments and hosting the Advice on a secured and encrypted website (Payee Portal). For the purposes of this invention, any Advice for any type of payment may be created and housed on the Payee Portal. Using payee information derived from the invoice, the payee is notified via SMTP, MMS, SMS, HTTP, HTTPs, FAX, FTP and other forms of communications electronic, digital or analog that an Advice is available to the payee for an invoice previously submitted by the payee to the payer. Within the notification is an authorization code (Auth) and unique identifier (ID) that facilitates the payee logging into the portal.

The payee is requested to collect the payment by visiting the hosting site via a link or URL depending on the notification type. The payee gains access to the site by using the Auth and ID as part of the required information for creating a login. The payee creates and stores login information for subsequent access to the payee portal hosting site.

Another embodiment of this invention includes establishing security between the payer and the payee. A successful enrollment initiates the production of the Security Device Interface (SDI) at the payer's location. The payer scans the SDI barcode printed on the side of the SDI and stores the unique barcode in the payee profile. The device is delivered to the payee; installed in the payee computer through a USB port; and the SDI is an integral part of the security for Accelerated Check processing. Without the SDI no Accelerated Check processing is performed.

Once installed the SDI employs a serial number circuit to return a serialized key when called. Used in conjunction with the unique machine key of the payee's computer, this value provides a custom key linking the computer, SDI Key and payer's servers. With the verification of all three data segments the payer's server contains a unique signature to assign to each Accelerated Check issued through that payee's computer. That unique signature is used in the Positive Pay secure check process at the payer's bank to confirm the validity of the Accelerated Check.

The payee selects payment type Accelerated Check and the Payee Portal displays the Accelerated Check in the browser window. The payee has the option of reviewing the check prior to printing. The payee accepts the payment amount and the SDI security module described in [0010] and [0011] creates the unique signature and prints that information on the Accelerated Check and includes that signature in the Positive Pay data record created and transmitted to the payer's bank via Secure File Transfer Protocol (SFTP). Comparing checks clearing on the payer's account to a Positive Pay record of valid checks and posting exceptions (possible fraudulent checks) is a standard bank process; however the inclusion in the positive pay process of the unique signature created by the SDI is an additional non-software non-duplicative embodiment of the current invention.

### BRIEF DESCRIPTION OF THE DRAWINGS

For a fuller understanding of the invention, reference should be made to the following detailed description, taken in connection with the accompanying drawings, in which:

FIG. 1 PRIOR ART is an illustration of the current state-of-the-art.

FIG. 2 is a diagrammatic view of an embodiment of the invention.

FIG. 3 is a flow chart illustration of an embodiment of the invention.

FIG. 4 is a flow chart illustration of an embodiment of the invention.

FIG. 5 is a diagrammatic view of an embodiment of the invention.

FIG. 6 is a diagrammatic view of an embodiment of the invention

### DETAILED DESCRIPTION OF THE PREFERRED EMBODIMENT

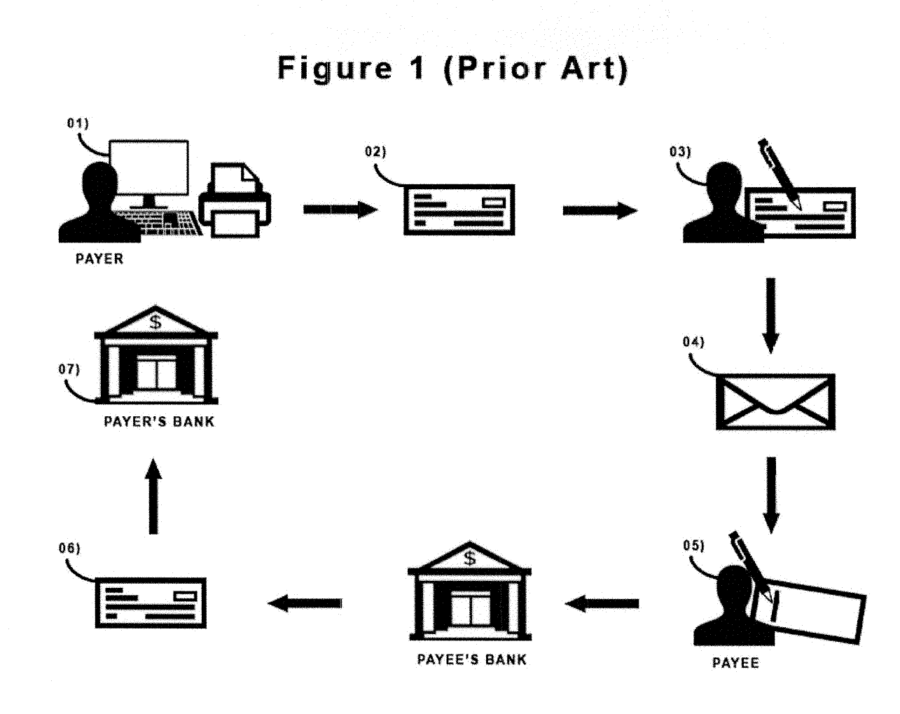

Turning to FIG. 1., (PRIOR ART), (01) Payer using a check writing accounting system, or pre-printed manual checks creates a paper check (02). Paper check is then manually or electronically signed (03). Paper check is then mailed to payee (04) who endorses or stamps the back of the check and deposits the check in payee's bank (05). Payee's bank updates accounts and transmits (06) copy of check to payer's bank (07). During (04), check is subject to theft, delay and fraud.

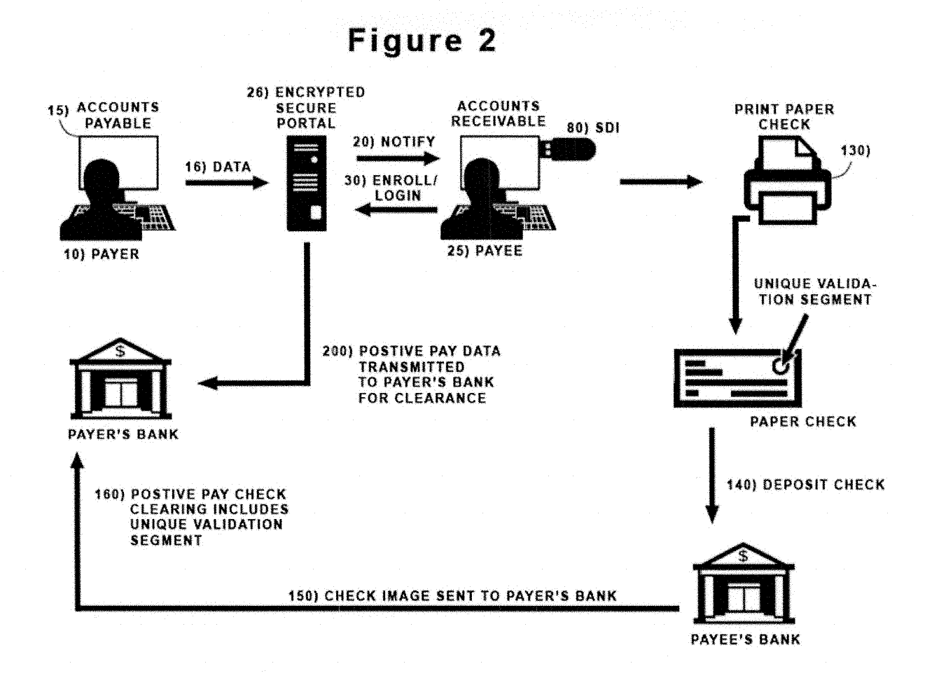

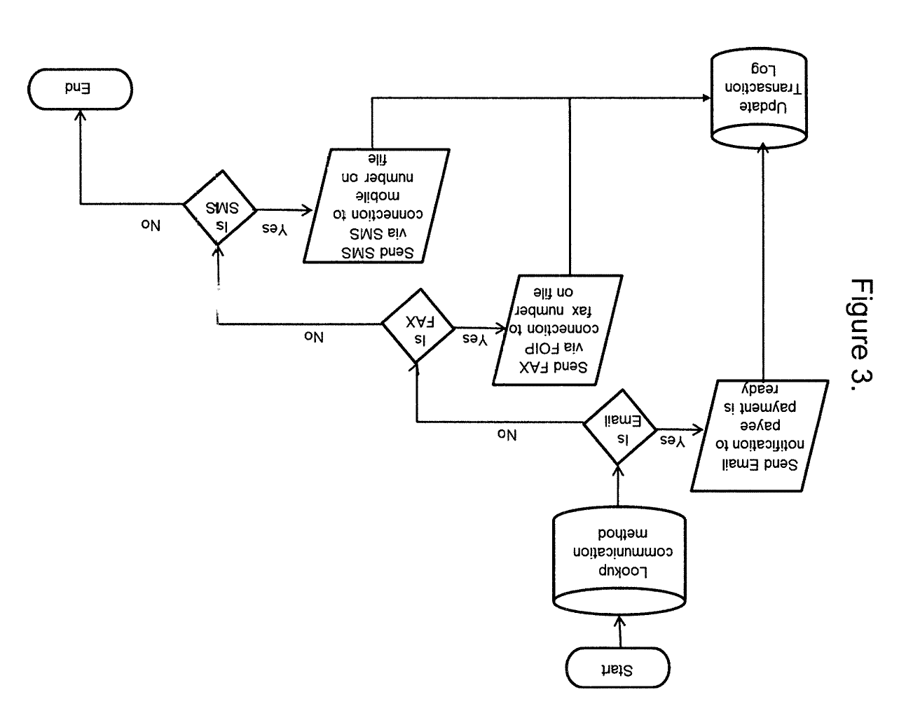

Turning to FIG. 2. Payer (10) logs into payer database on encrypted secure portal (15). Payer uploads data file (16) representing payments to be made to a payee (25). Data file is loaded into the payment database residing on the encrypted secure portal (26). An electronic notification (20) is automatically generated and transmitted to payee. See Flow Chart FIG. 3 Payee Notification Procedure. Once notified, payee logs into encrypted secure portal or if this is first time for payee notification, payee will enroll (30).

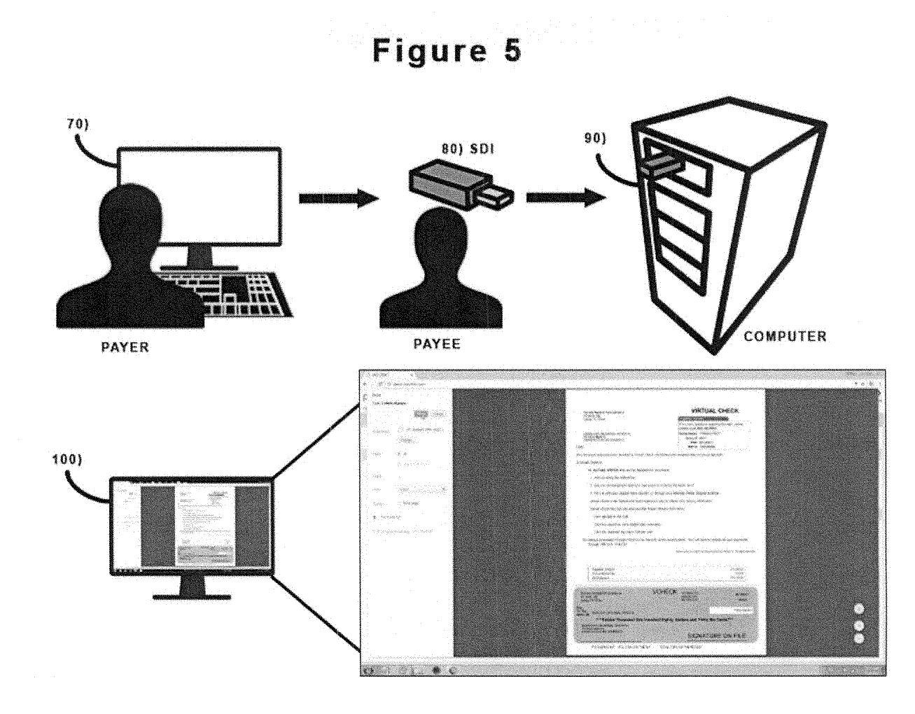

When enrollment is completed, see FIG. 5. Payer (70) initiates creation of security device interface (SDI) (80) and timely delivers device to payee. Upon receipt of SDI, payee installs SDI in payee's computer (90). On the event of payee's next login to encrypted secure portal SDI is activated by inboard software.

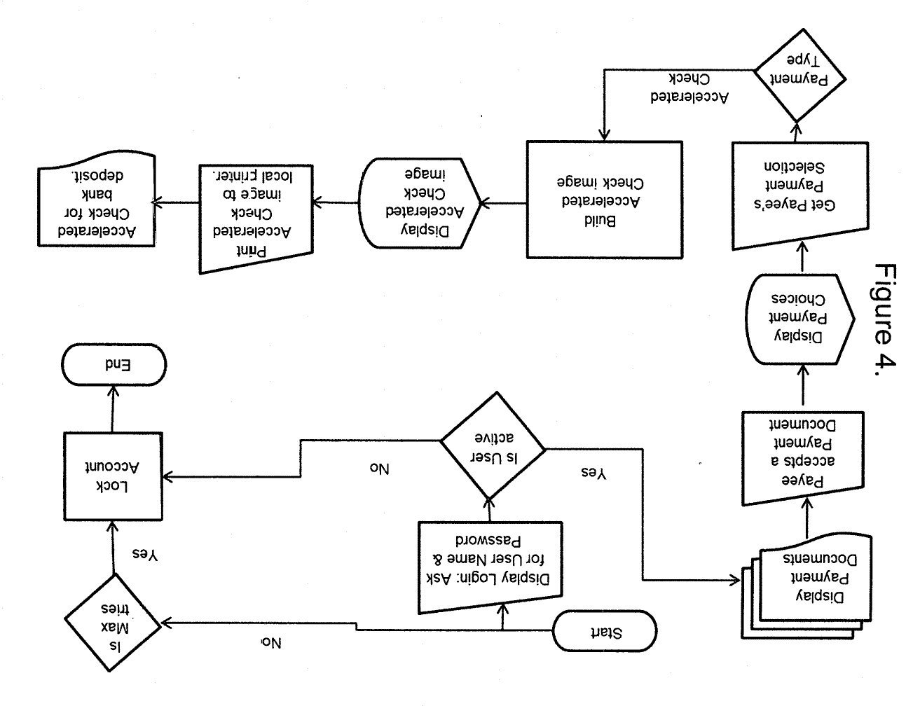

In FIG. 4 Flow Chart Payee Payment Collection Process, payee logs into encrypted secure portal (26) and accesses pending transaction screen using payee's local browser. Payee accesses digital representation of Remittance Advice, see FIG. 5 (100). In FIG. 4, from the “Display Payment Documents” Payee reviews and accepts a payment document as full payment. Next, from “Payment Choices” Payee select's the payment type Accelerated Check, and by pressing “Continue” on the browser button, executes the security process.—Encrypted Secure Portal builds and displays Accelerated Check on payee display for printing to payee's local printer.

SDI employs a serial circuit to return a serialized key (80). Once the SDI is installed in payee's computer via insertion in USB port, the serialized key is combined with the unique machine key of payee's computer, and the result, Unique Validation Segment, is stored on the payer's servers to create a unique linkage of the SDI, the computer and the payer's server. For each Accelerated Check data record (90), SDI produces a Unique Validation Segment that becomes part of the Positive Pay data record for the payer bank check security clearing process.

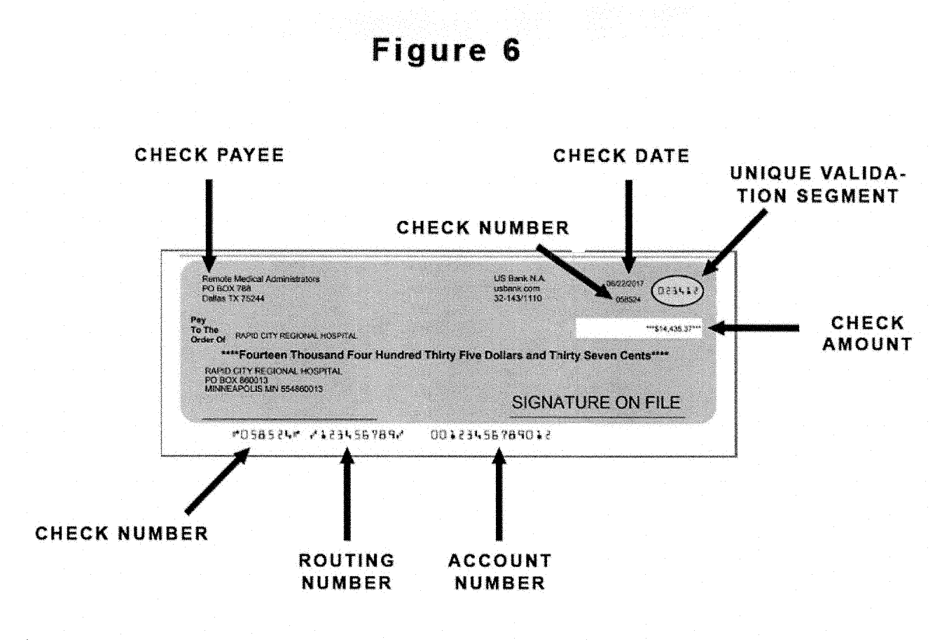

Turning again to FIG. 2., Payment data (200) from Accelerated Check is collected and transmitted to Payer's Bank for Positive Pay check data clearance process. Data collected is Check Payee, Check Amount, Check Date, Check Number, Account Number, and Unique Validation Segment. See FIG. 6. These values, used for validation of each check through payer's account reside at the Payer's Bank. Any presented check which has different values in any of the fields enumerated above than the Positive Pay data record is flagged as an exception and reviewed by the payer.

See FIG. 5 for a digital representation of Accelerated Check (100) with associated instructions is displayed to payee.

Turning to FIG. 2, (25) Payee uses the browser to print the Accelerated Check to payee's local printer. Payee collects Accelerated Check in form paper from printer (130) and prepares/endorses check for bank deposit or deposits via check scanning software.

Payee Deposits Accelerated Check in form paper (140) in Payee's Bank and receives immediate good funds (depending on bank relationship).

Accelerated Check in form image from Payee's Bank is transmitted (150), by normal banking methods between banks, to Payer's Bank within next 24 hours after deposit.

Normal banking procedures allow for presentment of the Accelerated Check in form image to Payer's Bank for Positive Pay approval. The normal banking Positive Pay process at Payer's bank compares values derived via Optical Character Recognition from the Accelerated Check image at the payee's bank and compares (160) those values with the data file containing the values gathered in Step (200). Exceptions of Positive Pay comparisons are noted to Payer.

What is claimed is:

1. A method of facilitating and securing faster paper check delivery and payment processing between payers and payees by establishing a payee portal with secure hardware enabled linkage to payee's local computer, Such computer contains a hardware device plug-in for secure printing and validation of locally printed checks and enhances positive pay check validation at payer's bank.

2. The method of claim 1 wherein Accelerated Check image is created in form of a PDF, JPEG, TIF, or any other type of tile or image which can replicate a paper check and all of the requisite fields, including but not limited to “pay to the order of”, “payee name”, “numerical dollar amount”, “word description of dollar amount”, “check date”, “check number”, “bank routing number”, and “bank account number”.

3. The method of claim 1 wherein payee enrolls in a website, the Payee Portal offered by payer, Payee is offered multiple payment types and selects the Accelerated Check type, Payee website displays a digital and browser printable image of the payee's requested check on the Payee Portal and may be viewed by the payee on the payee's computer display, The payee installs the Security Device Interface (SDI) in a USB port on that same computer, The SDI contains unique information required to create the Unique Validation Segment containing a unique security non-numeric or numeric code, The Unique Validation Segment and security code are added to the check image just prior to printing, Without the SDI in place the resulting check image will not contain the Unique Validation Segment and security code, In one embodiment the check is printed to payee's local printer through the Internet browser, The paper check is then deposited by the payee in the payee's bank

4. The method of claim 1 by which the Accelerated Check image is transmitted from the payer to the payee by electronic transmission, Electronic transmission means “the transfer of data or information through an, authorized electronic data interchange system consisting of, but not limited to, computer modems, computer networks, Internet or any other form of transmission”, such as SMTP, MMS, SMS, HTTP, HTTPs, FAX, FTP and others.

5. The method of claim 1 wherein information data contained on the check image are accumulated and transmitted electronically to the payer's bank by, but not limited to, computer moderns, computer networks, Internet or any other form of transmission, such as SMTP, MMS, SMS, HTTP, HTTPS, FAX, FTP and others, The information transferred is utilized at the payer's bank for positive pay validation on the check as it is presented.

6. The method of claim 1 wherein the Unique Validation Segment and security code created through the SDI is encrypted and contained in a universally accessible data file hosted by one or more banking institutions, Federal, Public or Private using Block Chain or other encryption security procedures.

7. The method of claim 1 wherein the Unique Validation Segment and security code and all requisite check information including but not limited to paper check fields is used to validate the checks authenticity as described in method 1.

8. The method of claim 1 wherein the security of the check printing and clearing is performed by the Bank or financial institution on which the check is drawn, performing all necessary security steps to validate the check as genuine and not duplicative or counterfeit.

9. The method of claim 1 wherein the security of the check clearing is determined by any third party entity offering a secure methodology to validate the check as genuine and not duplicative or counterfeit.
